(19) United States
(12) Patent Application Publication
(10) Pub. No.: US 2009/0125807 A1
(43) Pub. Date: May 14, 2009

(54) SYSTEM AND METHOD FOR WORDWISE PREDICTIVE CHINESE CHARACTER INPUT

(75) Inventor: MING-CHU CHEN, Tu-Cheng (TW)

Correspondence Address: PCE INDUSTRY, INC.;ATT. Steven Reiss, 458 E. LAMBERT ROAD, FULLERTON, CA, 92835, US

(73) Assignee: CHI MEI COMMUNICATION SYSTEMS, INC., Tu-Cheng City (TW)

(21) Appl. No.: 12/133,389

(22) Filed: Jun. 5, 2008

(30) Foreign Application Priority Data
Nov. 14, 2007 (CN) 200710202526.8

(51) Int. Cl. G06F 17/00

(52) U.S. Cl. 715/261

(57) ABSTRACT

A method for wordwise predictive Chinese character input includes following steps of: inputting a first Chinese character; generating a first prediction list of Chinese characters; displaying the first Chinese character and the first prediction list of Chinese characters; storing the first Chinese character and the first prediction list of Chinese characters; inputting a second Chinese character or selecting a second Chinese character; generating a second prediction list of Chinese characters; displaying the second Chinese character and the second prediction list of Chinese characters; storing the second Chinese character and the second prediction list of Chinese characters; deleting the second Chinese character and the second prediction list of Chinese characters if a clear key is pressed; and displaying the first Chinese character and the first prediction list of Chinese characters.

### BACKGROUND OF THE INVENTION

1. Field of the Invention

The present invention generally relates to systems and methods for wordwise predictive Chinese character input.

2. Description of Related Art

Generally, a handheld device is a pocket-sized computing device, which typically includes a small visual display for output and a miniature keyboard or touch screen for input. Specifically, the handheld device may be a mobile phone, a personal digital assistant (PDA), a handheld game player, a digital camera, or a palm computer, etc.

As handheld devices gain worldwide popularity, numerous language coding methods for handheld device have been developed. Because of the widespread use of the Chinese language, one common language coding method is Chinese and many handheld devices are installed with a Chinese text editor. Most of Chinese text editors provide a function for predicting Chinese character input. For example, if a user inputs a Chinese character [symbol] (ten) through a keyboard or a writing pad, the handheld device may display a dropdown prediction list [symbol] (minute), [symbol] (year), [symbol] (hour), [symbol] (clock), and [symbol] (month) to the user. If the prediction list has a Chinese character that the user wants to input, the user can select the Chinese character from the prediction list instead of inputting the Chinese character through the keyboard or the writing pad thereby saving keystrokes or using the writing pad. However, if the user inadvertently selects the wrong Chinese character from the prediction list, the user must use the keyboard or writing pad to input the correct Chinese character. Therefore, the existing function of predictive Chinese character input has some disadvantages, such as, inefficiency and time-consuming.

Accordingly, what is needed is a system and method for wordwise predictive Chinese character input, which can return a previously closed prediction lists.

### SUMMARY OF THE INVENTION

A system for wordwise predictive Chinese character input is provided. The system is installed in a handheld device and includes an inputting module, a generating module, a displaying module, a storing module, and a deleting module. The inputting module is configured for inputting a first Chinese character through an input device of the handheld device. The generating module is configured for generating a first prediction list of Chinese characters that commonly follow the first Chinese character. The displaying module is configured for displaying the first Chinese character and the first prediction list of Chinese characters on a display screen of the handheld device. The storing module is configured for storing the first Chinese character and the first prediction list of Chinese characters into a stack of the handheld device. The inputting module is further configured for inputting a second Chinese character or selecting a second Chinese character from the first prediction list of Chinese characters through the input device. The generating module is further configured for generating a second prediction list of Chinese characters that commonly follow the second Chinese character. The displaying module is further configured for displaying the second Chinese character and the second prediction list of Chinese characters on the display screen. The storing module is further configured for storing the second Chinese character and the second prediction list of Chinese characters into the stack. The deleting module is configured for deleting the second Chinese character and the second prediction list of Chinese characters from the stack if a clear key of the handheld device is pressed. The displaying module is further configured for reading the first Chinese character and the first prediction list of Chinese characters from the stack, and displaying the first Chinese character and the first prediction list of Chinese characters on the display screen.

Other systems, methods, features, and advantages will be or become apparent to one skilled in the art upon examination of the following drawings and detailed description.

### BRIEF DESCRIPTION OF THE DRAWINGS

FIG. 1 is a functional block diagram of a system for wordwise predictive Chinese character input in accordance with an exemplary embodiment;

FIG. 2 is a flowchart of a method for wordwise predictive Chinese character input in accordance with the exemplary embodiment; and

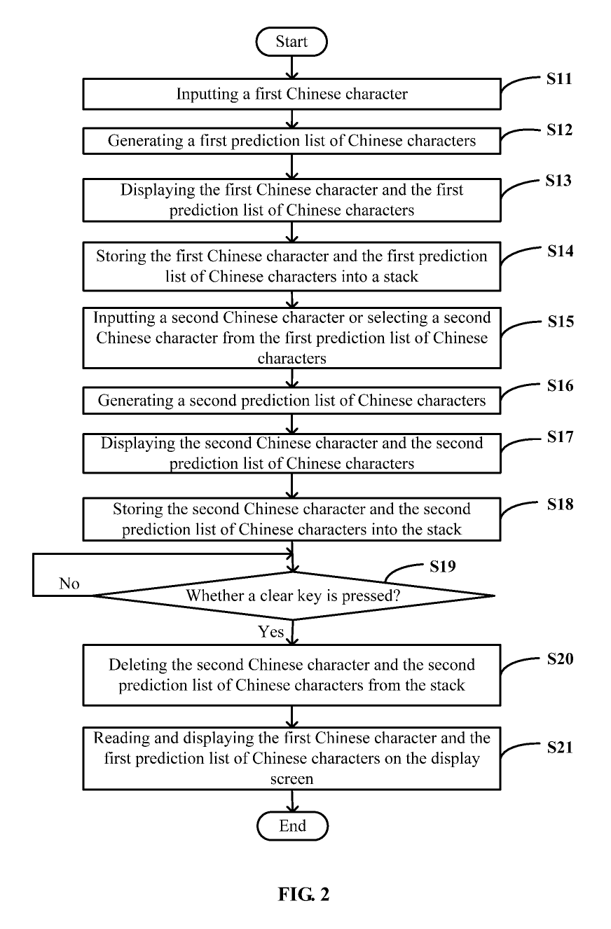

FIG. 3 is a schematic drawing of displaying a prediction list of Chinese characters in accordance with an exemplary embodiment.

### DETAILED DESCRIPTION OF THE INVENTION

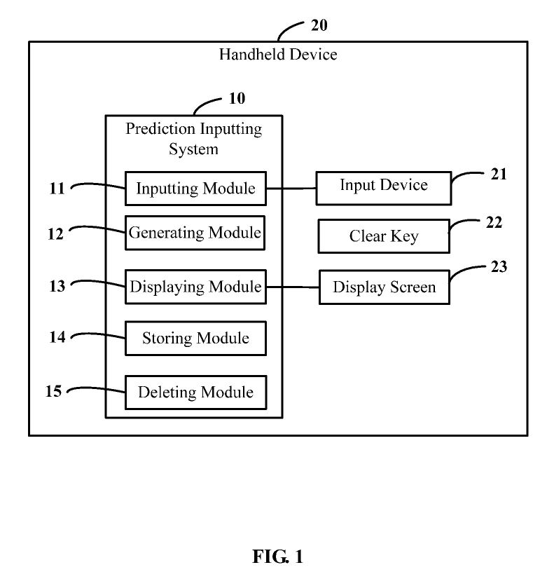

FIG. 1 is a functional block diagram of a system for wordwise predictive Chinese character input (hereinafter, “the predictive input system”) in accordance with an exemplary embodiment. In the exemplary embodiment, the predictive input system 10 is installed and run in a handheld device 20, which further includes an input device 21, a clear key 22, and a display screen 23. In other embodiments, the predictive input system 10 may be installed in a computer or other kinds of electronic apparatus.

The handheld device 20 may be a mobile phone, a personal digital assistant (PDA), a handheld game player, a digital camera, a palm computer, or other portable electronic devices. The input device 21 may be a keyboard or a writing pad.

The predictive input system 10 includes an inputting module 11, a generating module 12, a displaying module 13, a storing module 14 and a deleting module 15.

The inputting module 11 is configured for inputting a first Chinese character through the input device 21.

The generating module 12 is configured for generating a first prediction list of Chinese characters that commonly follow the first Chinese character. For example, if the inputting module 11 inputs a first Chinese character [symbol] (ten), a first prediction list of Chinese characters generated by the generating module 12 may be [symbol] ” (minute), [symbol] (year), [symbol] (hour), [symbol] (clock), and [symbol] (month).

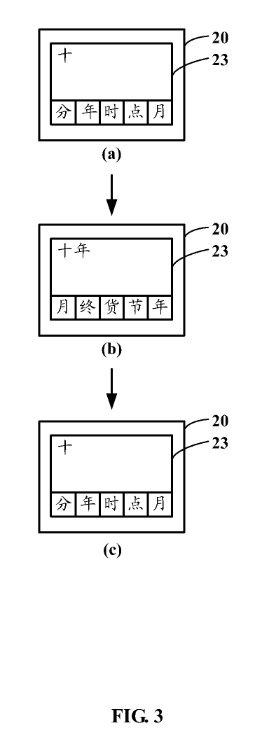

The displaying module 13 is configured for displaying the first Chinese character and the first prediction list of Chinese characters on the display screen 23. For example, in FIG. 3 (a), the displaying module 13 displays the first Chinese character [symbol] (ten) and the first prediction list [symbol] (minute), [symbol] (year), [symbol] (hour), [symbol] (clock), and [symbol] (month) on the display screen 23 after the first Chinese character [symbol] (ten) is inputted by the inputting module 11.

The storing module 14 is configured for storing the first Chinese character and the first prediction list of Chinese characters into a stack of the handheld device 20. The stack is a Last In, First Out (LIFO) queue.

The inputting module 11 is further configured for inputting a second Chinese character or selecting a second Chinese character from the first prediction list of Chinese characters through the input device 21.

The generating module 12 is further configured for generating a second prediction list of Chinese characters that commonly follow the second Chinese character. For example, if the inputting module 11 selects a second Chinese character [symbol] (year) from the first prediction list [symbol] (minute), [symbol] (year), [symbol] (hour), [symbol] (clock), and [symbol] (month), a second prediction list of Chinese characters generated by the generating module 12 may be [symbol] (month), [symbol] (end), [symbol] (goods), [symbol] ” (festival), and [symbol] (year).

The displaying module 13 is further configured for displaying the second Chinese character and the second prediction list of Chinese characters on the display screen 23. For example, in FIG. 3 (b), the displaying module 13 displays the second Chinese character [symbol] (year) and the second prediction list [symbol] (month), [symbol] (end), [symbol] (goods), [symbol] (festival), and [symbol] (year) on the display screen 23 after the second Chinese character [symbol] (year) is selected by the inputting module 11.

The storing module 14 is further configured for storing the second Chinese character and the second prediction list of Chinese characters into the stack.

The deleting module 15 is configured for deleting the second Chinese character and the second prediction list of Chinese characters from the stack if the clear key 22 is pressed. For example, in the exemplary embodiment, the deleting module 15 deletes the second Chinese character [symbol] (year) and the second prediction list [symbol] (month), [symbol] (end), [symbol] (goods), [symbol] (festival), and [symbol] (year) from the stack. After deleting the second Chinese character and the second prediction list, the current Chinese character in the stack is [symbol] (ten), and the current prediction list in the stack is [symbol] (minute), [symbol] (year), [symbol] (hour), [symbol] (clock), and [symbol] (month).

The displaying module 13 is further configured for reading the first Chinese character and the first prediction list of Chinese characters from the stack, and displaying the first Chinese character and the first prediction list of Chinese characters on the display screen 23. For example, in FIG. 3 (c), the displaying module 13 displays the first Chinese character [symbol] (ten) and the first prediction list [symbol] ” (minute), [symbol] (year), [symbol] (hour), [symbol] (clock), and [symbol] (month) on the display screen 23 after the clear key 22 is pressed and the second Chinese character and the second prediction list is deleted.

In the exemplary embodiment, the inputting module 11 is not limited to input the first Chinese character and the second Chinese character, the inputting module 11 can input a plurality of Chinese characters. In this condition, the last two inputted Chinese characters would correspondingly become the first Chinese character and the second Chinese character described previously. Also, the generating module 12 can generate several prediction lists of Chinese characters according to the several Chinese characters, the displaying module 13 can display the several Chinese characters and the several prediction lists of Chinese characters, the storing module 14 can store the several Chinese characters and the several prediction lists of Chinese characters into the stack.

FIG. 3 is a flowchart of a method for wordwise predictive Chinese character input in accordance with the exemplary embodiment.

In step S11, the inputting module 11 inputs a first Chinese character through the input device 21.

In step S12, the generating module 12 generates a first prediction list of Chinese characters that commonly follow the first Chinese character.

In step S13, the displaying module 13 displays the first Chinese character and the first prediction list of Chinese characters on the display screen 23.

In step S14, the storing module 14 stores the first Chinese character and the first prediction list of Chinese characters into the stack.

In step S15, the inputting module 11 inputs a second Chinese character or selects a second Chinese character from the first prediction list of Chinese characters through the input device 21.

In step S16, the generating module 12 generates a second prediction list of Chinese characters that commonly follow the second Chinese character.

In step S17, the displaying module 13 displays the second Chinese character and the second prediction list of Chinese characters on the display screen 23.

In step S18, the storing module 14 stores the second Chinese character and the second prediction list of Chinese characters into the stack.

In step S19, it is determined whether the clear key 22 is pressed.

In step S20, if the clear key 22 is pressed, the deleting module 15 deletes the second Chinese character and the second prediction list of Chinese characters from the stack.

In step S21, the displaying module 13 reads the first Chinese character and the first prediction list of Chinese characters from the stack, and displays the first Chinese character and the first prediction list of Chinese characters on the display screen 23, and the procedure ends.

If the clear key 22 is not pressed in step S19, the procedure return to the step S19.

It should be emphasized that the above-described embodiments of the exemplary embodiments, particularly, any “exemplary embodiments, are merely possible examples of implementations, merely set forth for a clear understanding of the principles of the invention. Many variations and modifications may be made to the above-described exemplary embodiment(s) without departing substantially from the spirit and principles of the invention. All such modifications and variations are intended to be included herein within the scope of this disclosure and the above-described exemplary embodiment(s) and protected by the following claims.

What is claimed is:

1. A system for wordwise predictive Chinese character input, the system being installed in a handheld device, the system comprising:
an inputting module configured for inputting a first Chinese character through an input device of the handheld device;
a generating module configured for generating a first prediction list of Chinese characters that commonly follow the first Chinese character;
a displaying module configured for displaying the first Chinese character and the first prediction list of Chinese characters on a display screen of the handheld device;
a storing module configured for storing the first Chinese character and the first prediction list of Chinese characters into a stack of the handheld device;
the inputting module is further configured for inputting a second Chinese character or selecting a second Chinese character from the first prediction list of Chinese characters through the input device;
the generating module is further configured for generating a second prediction list of Chinese characters that commonly follow the second Chinese character;
the displaying module is further configured for displaying the second Chinese character and the second prediction list of Chinese characters on the display screen;
the storing module is further configured for storing the second Chinese character and the second prediction list of Chinese characters into the stack;
a deleting module configured for deleting the second Chinese character and the second prediction list of Chinese characters from the stack if a clear key of the handheld device is pressed; and
the displaying module is further configured for reading the first Chinese character and the first prediction list of Chinese characters from the stack, and displaying the first Chinese character and the first prediction list of Chinese characters on the display screen.

2. The system according to claim 1, wherein the input device is a keyboard or a writing pad.

3. The system according to claim 1, wherein the handheld device is a mobile phone, a personal digital assistant, a handheld game player, a digital camera, or a palm computer.

4. A method for wordwise predictive Chinese character input, the method comprising:
providing a handheld device and inputting a first Chinese character through an input device of the handheld device;
generating a first prediction list of Chinese characters that commonly follow the first Chinese character;
displaying the first Chinese character and the first prediction list of Chinese characters on a display screen of the handheld device;
storing the first Chinese character and the first prediction list of Chinese characters into a stack of the handheld device;
inputting a second Chinese character or selecting a Chinese second character from the first prediction list of Chinese characters through the input device;
generating a second prediction list of Chinese characters that commonly follow the second Chinese character;
displaying the second Chinese character and the second prediction list of Chinese characters on the display screen;
storing the second Chinese character and the second prediction list of Chinese characters into the stack;
determining whether a clear key of the handheld device is pressed;
deleting the second Chinese character and the second prediction list of Chinese characters from the stack if the clear key is pressed; and
reading the first Chinese character and the first prediction list of Chinese characters from the stack, and displaying the first Chinese character and the first prediction list of Chinese characters on the display screen.

5. The method according to claim 4, wherein the input device is a keyboard or a writing pad.

6. The method according to claim 4, wherein the handheld device is a mobile phone, a personal digital assistant, a handheld game player, a digital camera, or a palm computer.
